(19) United States
(12) Patent Application Publication
(10) Pub. No.: US 2025/0196010 A1
(43) Pub. Date: Jun. 19, 2025

(54) METHOD AND APPARATUS FOR PROVIDING GAME

(71) Applicant: NCSOFT Corporation, Seoul (KR)

(72) Inventor: Min Seong KIM, Seongnam-si (KR)

(73) Assignee: NCSOFT Corporation, Seoul (KR)

(21) Appl. No.: 19/066,502

(22) Filed: Feb. 28, 2025

Related U.S. Application Data
(63) Continuation of application No. PCT/KR2023/016406, filed on Oct. 20, 2023.

(51) Int. Cl. A63F 13/58; A63F 13/56

(52) U.S. Cl. CPC A63F 13/58; A63F 13/56

(57) ABSTRACT

Disclosed are a method and apparatus for providing a game. The method, according to an embodiment of the disclosure, comprises determining a generation probability for one or more random objects to be placed on a field based on a game progress situation within the field where game play of a plurality of users is performed, and generating the one or more random objects on the field based on the generation probability.

### CROSS-REFERENCE TO RELATED APPLICATIONS

This application is a Continuation Application of International Application PCT/KR2023/016406 filed on Oct. 20, 2023, at the Korean Intellectual Property Office, the disclosures of which are incorporated herein in their entireties by reference.

### TECHNICAL FIELD

The disclosed embodiments relate to technology for providing a game.

### BACKGROUND ART

As the genre of games has diversified, including brawl-type action games in which plurality of players compete against each other or form a party to compete against plurality of parties as a type of action game genre, and types of gaming devices and input devices that can be used for game play have diversified, the number of users who enjoy games has increased significantly, and competition in the game industry has also increased day by day.

Therefore, providing a new play experience to users who play the game and providing convenience in game play has become an essential element in securing the competitiveness of the game.

### SUMMARY

The disclosed embodiments are intended to provide a method and an apparatus for providing a game.

A method, according to an embodiment of the disclosure, comprises determining a generation probability for one or more random objects to be placed on a field based on a game progress situation within the field where game play of a plurality of users is performed, and generating the one or more random objects on the field based on the generation probability.

The one or more random objects may include an object for which at least one of generation time, generation location, and whether-or-not-to-generate is determined based on the game progress situation.

The game progress situation may include at least one of a position of a game character of each of the plurality of users within the field, a movement path of the game character of each of the plurality of users, a movement amount of the game character of each of the plurality of users, a physical strength of the game character of each of the plurality of users, a number of remaining game characters among game characters of each of the plurality of users, and a remaining time until the end of the game.

The determining may comprise determining the generation probability for each area within the field based on the location of the game character of each of the plurality of users within the field.

The determining may further comprise determining the generation probability so that an area with a higher density of game characters for each of the plurality of users within the field has a higher generation probability.

The determining may further comprise determining the generation probability so that an area where the game character of each of the plurality of users stays for a longer time has a higher generation probability.

The field may include a safe zone and a danger zone, the safe zone may be updated at each preset area update cycle, such that some areas within an existing safe zone are set as a new safe zone each time the area update cycle starts, and remaining areas within the existing safe zone, excluding the new safe zone, are changed to the danger zone each time the area update cycle ends, and some areas of the danger zone may be randomly generated within the existing safe zone or the new safe zone regardless of the area update cycle.

A computing device, according to an embodiment of the disclosure, comprises one or more processors, and a memory storing one or more programs executed by the one or more processors, wherein the one or more processors are configured to determine a generation probability for one or more random objects to be placed on a field based on a game progress situation within the field where game play of a plurality of users is performed, and generate the one or more random objects on the field based on the generation probability.

The one or more random objects may include an object for which at least one of generation time, generation location, and whether-or-not-to-generate is determined based on the game progress situation.

The game progress situation may include at least one of a position of a game character of each of the plurality of users within the field, a movement path of the game character of each of the plurality of users, a movement amount of the game character of each of the plurality of users, a physical strength of the game character of each of the plurality of users, a number of remaining game characters among game characters of each of the plurality of users, and a remaining time until the end of the game.

The one or more processors may be further configured to determine the generation probability for each area within the field based on the location of the game character of each of the plurality of users within the field.

The one or more processors may be further configured to determine the generation probability so that an area with a higher density of game characters for each of the plurality of users within the field has a higher generation probability.

The one or more processors may be further configured to determine the generation probability so that an area where the game character of each of the plurality of users stays for a longer time has a higher generation probability.

The field may include a safe zone and a danger zone, the safe zone may be updated at each preset area update cycle, such that some areas within an existing safe zone are set as a new safe zone each time the area update cycle starts, and remaining areas within the existing safe zone, excluding the new safe zone, are changed to the danger zone each time the area update cycle ends, and some areas of the danger zone may be randomly generated within the existing safe zone or the new safe zone regardless of the area update cycle.

According to the disclosed embodiments, it is possible to provide improved game play convenience to users playing the game while providing a new user experience.

### BRIEF DESCRIPTION OF THE DRAWINGS

FIGS. 1 to 6 are diagrams for illustratively describing a main screen of a game according to an embodiment.

FIG. 7 is a diagram for illustratively describing a game start location selection in a battle royale mode according to an embodiment.

FIG. 8 is a diagram for illustratively describing item selection in a build-up mode according to an embodiment.

FIG. 9 is a diagram for illustratively describing a safety zone according to an embodiment.

FIGS. 10 to 12 are diagrams for illustratively describing a configuration of a game play screen according to an embodiment.

FIGS. 13 to 16 are diagrams for illustratively describing graphic images representing at least one of an attack type, an attack range, and an attack direction of a specific attack skill according to an embodiment.

FIG. 17 is a block diagram for illustratively describing a computing environment including a computing device according to an embodiment.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or workers. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

Hereinafter, “game” means software that one or more gamers can enjoy using an input device installed or connected to a gaming device. It is usually played by directly controlling a player character or controlling the movement of objects in the game, and is sometimes categorized into genres such as role-playing games (RPGs), massively multiplayer online role-playing games (MMORPGs), adventure games, and arcade games.

Hereinafter, “gaming device” means hardware that executes game software, performs operations based on user's input through the input device, and outputs results through an output device. For example, the gaming device may be in the form of a personal computer, a laptop computer, a game console, a smart phone, a tablet PC, an ultra-mobile personal computer (UMPC), a wearable device (e.g., a smart band, a smart watch, etc.), but any hardware that satisfies the definition described above is interpreted as belonging to the gaming device.

Hereinafter, “online game” means a game that should go through a network for the play of the game. Typically, it means a game in which two or more gaming devices in a remote location are connected to each other via a network or synchronized through a server and enjoyed. There is no limitation on the form of the gaming device that runs a game as long as it satisfies the definition described above. Games that run on personal computers or game consoles, as well as games that run on mobile devices such as smartphones, or games running on a plurality of different gaming devices (including different types of gaming devices) linked together or run in the cloud are also interpreted as online games if they satisfy the definition described above.

Hereinafter, “input device” means a device for inputting data into a gaming device. For example, a joystick, a mouse, a keyboard, a touch screen, a hardware button, or an input device dedicated to game manipulation manufactured in the form of a steering wheel, a musical instrument, a gun, a glove, a scaffold, etc. may be included as examples thereof. In addition, various sensors (temperature sensors, infrared sensors, motion sensors, gyro sensors, acceleration sensors, gravity sensors, etc.) mounted on or linked to gaming devices, or positioning means such as global positioning systems (GPS), indoor positioning systems, etc. may also be included examples of input devices.

The game according to an embodiment may be a brawl-type battle action game in which a plurality of players compete against each other or form a party to compete against a plurality of parties.

The game according to an embodiment may be executed on various gaming devices having different platforms, such as mobile devices such as smartphones and tablet PCs, game consoles, personal PCs, etc., and may support cross-platform play that allows users using gaming devices having different platforms to play together.

### Main Screen Configuration of Game

A game according to an embodiment may be run through a game application installed on a gaming device. Specifically, the user may execute a game application installed on the gaming device and then perform user authentication through a login screen provided through the game application to log in to a game service through his or her game account registered in the game service.

Meanwhile, if the user successfully logs in to the game service, a main screen of the game may be displayed on the gaming device. According to an embodiment, the user may provide information on various contents provided in the game, select or change settings for game play (e.g., game mode selection, operation-related settings, screen-related settings, sound-related settings, UI-related settings, friend-related settings, game character-related settings, etc.), or receive various information (e.g., item discount event, daily mission or quest information, etc.) related to the game, through the main screen.

Meanwhile, according to an embodiment, the main screen may include a main page for each of a plurality of contents provided in the game and one or more subpages for each main page. In this case, the plurality of contents may include, for example, game play, an item store, item generation, provision of game character-related information, game character customizing, provision of game statistical information, etc., but are not necessarily limited thereto, and may include various contents depending on the implementation in addition to the examples described above.

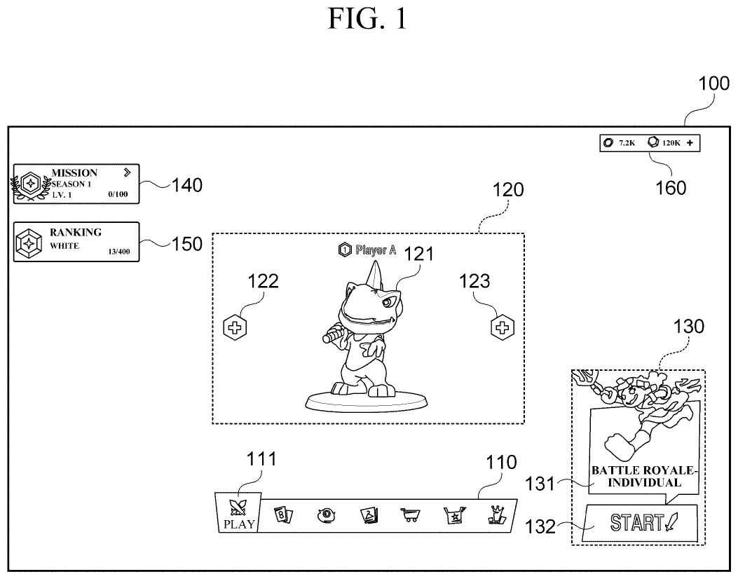

FIGS. 1 to 6 are diagrams for illustratively describing a main screen of a game according to an embodiment.

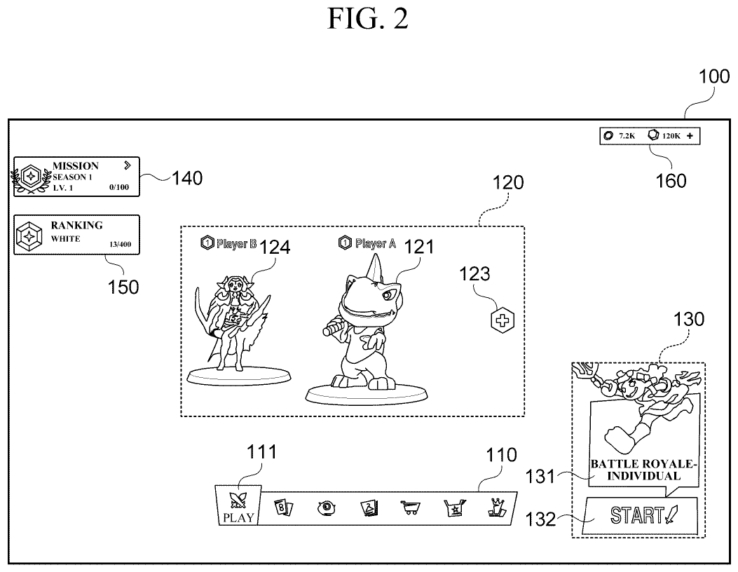

Referring to FIGS. 1 and 2, on a main screen 100 of a game according to an embodiment, a main menu UI 110 for enable a user to switch the main page displayed on the main screen 100 to one of main pages for each of a plurality of contents may be displayed.

A user may select a specific content by selecting a UI element for the desired content among UI elements displayed on the main menu UI 110, and in this case, a main page for the selected content may be displayed on the main screen 100. In addition, when the user selects a UI element corresponding to a second content in the main menu UI 110 while a main page or sub-page for a first content is displayed on the main screen 100, a page displayed on the main screen 100 may be switched from the main page for the first content to the main page for the second content.

Meanwhile, as in the illustrated example, the main menu UI 110 may be displayed on a lower area of the main screen 100 in the form of a navigation bar in which a UI element corresponding to each content is displayed in the form of an icon. In addition, UI elements 111 and 112 selected by the user in the main menu UI 100 may be displayed so as to be visually distinguished from other UI elements. For example, the UI elements 111 and 112 selected by the user in the main menu UI 110 may be displayed so that at least one of size, color and shape is different compared to other UI elements, or a preset graphic effect (e.g., a highlight effect) may be applied to the UI elements 111 and 112.

Meanwhile, according to an embodiment, a configuration of the main page for each content may be different for each content.

Specifically, FIG. 1 illustrates an example of a main page displayed on the main screen 100 when the UI 111 corresponding to game play content is selected in the main menu UI 110.

As illustrated in the example of FIG. 1, the main page for game play content according to an embodiment may include a game character display area 120, a game mode selection UI 130, a mission information provision UI 140, a statistical information provision UI 150, a goods information display area 160, etc.

One or more game characters 121 related to the user may be displayed in the game character display area 120. In this case, the game character 121 related to the user may include the user's game character. The user's game character may include, for example, a game character selected by the user in a recent game play, a game character with the highest number of plays by the user, a representative game character set by the user, a game character customized by the user, etc.

In addition, the game character related to the user may include, for example, a game character of another user designated by the user. In this case, the other user may include, for example, a user who is in a party or friends with the user within the game. Meanwhile, other users' game characters may include game characters selected by other users in recent game play, game characters with the highest number of plays by other users, representative game characters set by other users, game characters customized by other users, etc.

Meanwhile, the user's character 121 may be displayed in the center of the game character display area 120, and the user may select one of the UI elements 122 and 123 displayed in the game character display area 120 to determine a game character to be displayed at a location where the selected UI element 122 and 123 is displayed. For example, if the left UI element 122 among the UI elements 122 and 123 is selected by the user, a list of other users who are in a party or friend relationship with the user may be displayed, and the user may select a specific user from the list. In this case, as in the example illustrated in FIG. 2, a game character 124 of the selected specific user may be displayed at the location where the left UI element 122 was displayed.

Meanwhile, character identification information such as a user ID, a user nickname or a character nickname, a character level, etc., for example, may be displayed in each of the game characters 121 and 124 displayed in the game character display area 120.

Meanwhile, the game mode selection UI 130 is a UI provided to enable a user to select and play a desired game mode. Specifically, the game mode selection UI 130 may include a UI element 131 for selecting a game mode and a UI element 132 for starting game play according to the selected game mode.

Specifically, each of UI elements 131 and 132 included in the game mode selection UI 130 may be displayed in the form of a button, and a graphic image, text, etc. indicating the currently selected game mode may be displayed in the UI element 131 for selecting a game mode.

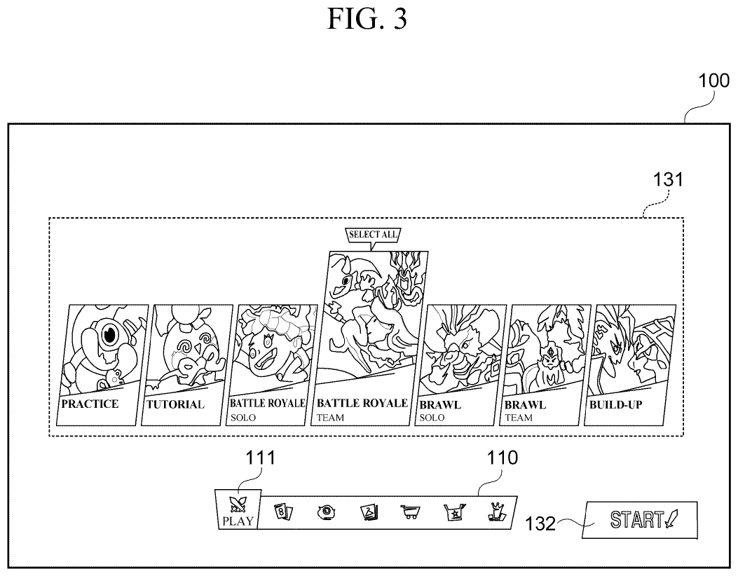

Meanwhile, referring to FIG. 1 and FIG. 3, if a user selects a UI element 131 for game mode selection in a game mode selection UI 130, on the main screen 100, may display a subpage in which the UI element 131 for game mode selection is displayed in the form of a game mode list, for example, as illustrated in the example in FIG. 3, or the UI element 131 for game mode selection may be changed to the form of a game mode list while the main page for game play content is maintained. In this case, the user may select a desired game mode from the UI element 131 displayed in the form of the game mode list.

Meanwhile, the mission information provision UI 140 may be a UI for providing information related to a mission that the user can perform. Specifically, the mission provided through the mission information provision UI 140 may be updated at regular intervals (e.g., daily, weekly, etc.) or updated when the user completes all given missions. Meanwhile, if the user selects the mission information provision UI 140, the mission information provision UI 140 may be changed to a form of a mission list that displays information on one or more missions (e.g., mission difficulty, completion reward, completion status, mission name, etc.).

The statistical information provision UI 150 may be a UI for providing statistical information related to the user's game play. Specifically, the statistical information provided through the statistical information provision UI 150 may include various information that may be granted or derived based on the user's game play history, such as the user's ranking, accumulated experience, user level, win rate, etc. Meanwhile, if the user selects the statistical information provision UI 150, the statistical information provision UI 150 may be changed to the form of a statistical information list that displays one or more statistical information.

The goods information display area 160 may display the amount of in-game goods owned by the user. In this case, the in-game goods may include, for example, various types of goods that may be obtained through game play or purchased by the user through payment.

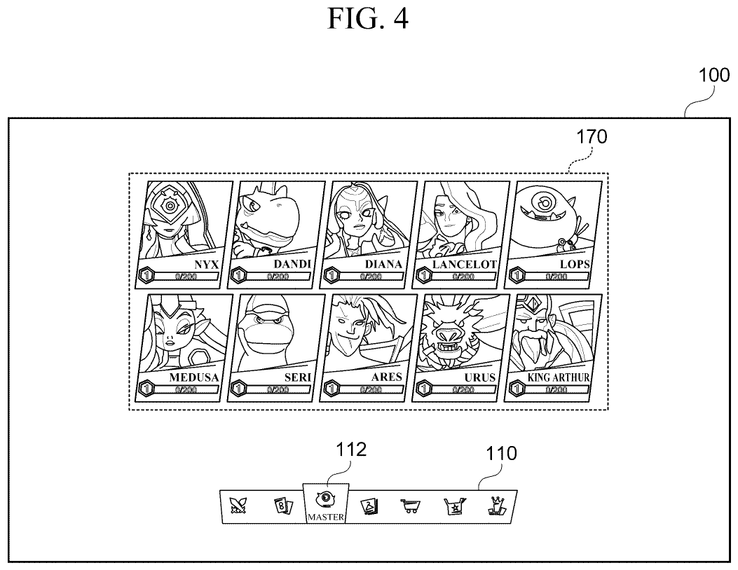

Meanwhile, FIG. 4 illustrates an example of a main page for game play content displayed on the main screen 100 when a UI element 112 corresponding to game character introduction content is selected in the main menu UI 110.

Referring to FIG. 4, in the main page for game play content, a character list 170 including game characters that the user can select and play in the game may be displayed. In this case, in the character list 170, for example, character images, character names, etc. for each game character may be displayed in the form of cards.

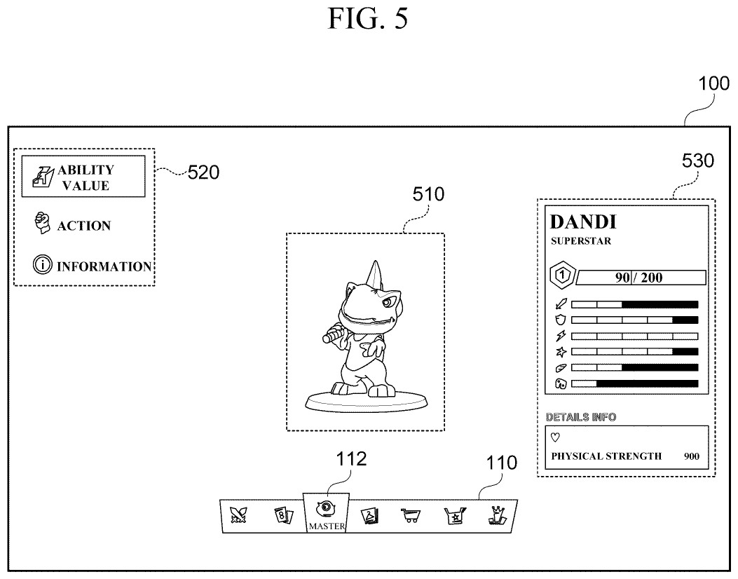

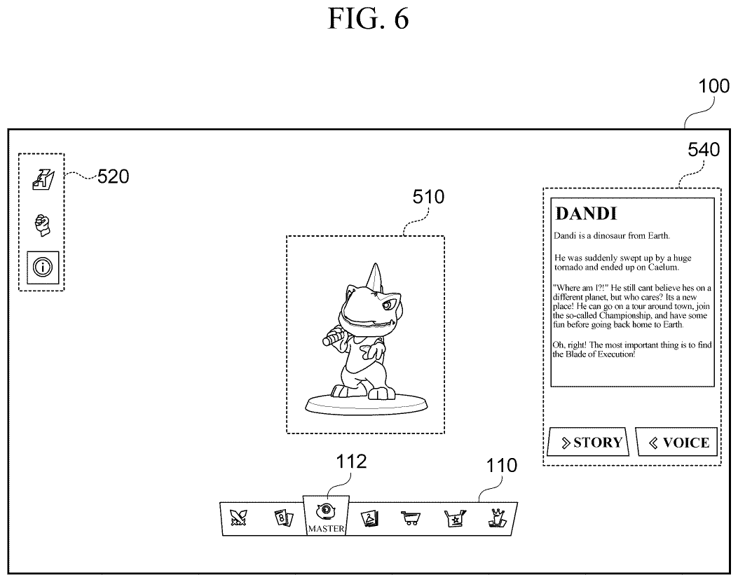

Meanwhile, if a specific character is selected from a character list 170 by the user, a character introduction page for the selected character may be displayed on the main screen 100 of the game, as in the example illustrated in FIG. 5 and FIG. 6.

Specifically, referring to FIG. 5 and FIG. 6, the character introduction page may include a character display area 510 where the selected game character is displayed and an introduction item selection UI 520 for selecting a character introduction item. Meanwhile, if a specific item is selected in the introduction item selection UI 520, information about the selected item may be displayed on the character introduction page. The game character's ability value may be displayed in one area of the character introduction page. Specifically, if an ability value item is selected in the introduction item selection UI 520, information about the ability value of a game character 530 may be displayed, as in the example illustrated in FIG. 5, and detailed information may be displayed in text form. In addition, if an information item is selected in the introduction item selection UI 520, information 540 such as a story, voice, etc. related to the game character may be provided, as in the example illustrated in FIG. 6.

Meanwhile, the configuration of the main screen of the game according to an embodiment is not necessarily limited to the examples illustrated in FIGS. 1 to 6 and may be changed in various ways according to embodiments.

### Game Mode

The game according to an embodiment may provide a plurality of game modes. In this case, according to an embodiment, the game mode may include, but is not necessarily limited to, a practice mode, a tutorial mode, a battle royale mode, a Brawl mode, a build-up mode, etc.

According to an embodiment, the practice mode and the tutorial mode may be game modes provided to allow a user who is not familiar with game play to learn how to operate a game character or game play rules, etc.

Specifically, the practice mode may be a mode configured to allow a user to freely select and operate a desired game character and learn how to operate the game character. According to an embodiment, the practice mode may be configured to allow a user to summon a desired number of practice opponent characters by type and fight against the opponent characters. In addition, according to an embodiment, the practice mode may be configured to provide a challenge to the user so that the user can learn how to operate the game character step by step through the challenge.

Meanwhile, the tutorial mode may be a mode provided to explain to the user various information necessary for game play, such as how to control the game character, how to progress the game according to a game mode, how to use items, and how to obtain items.

According to an embodiment, the battle royale mode is a game mode in which a number of users select their own game characters and compete against each other in a designated space with the goal of surviving until the end and may be divided into an individual match and a team match.

Specifically, the individual match is a mode in which a number of users use their own selected game characters to fight each other within a designated space until the last person remains, and the team match may be a mode in which a preset number of users (e.g., 3 people) form a team and a plurality of teams fight each other until the last team remains.

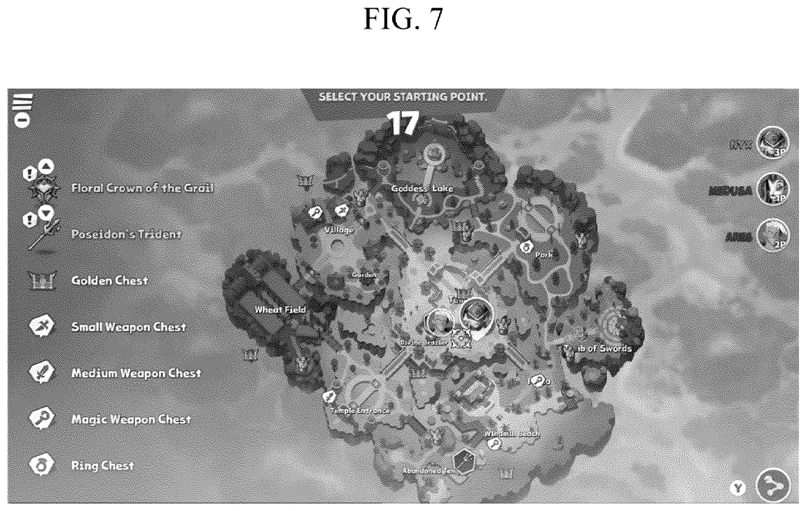

FIG. 7 is a diagram for illustratively describing the selection of a game start location in the battle royale mode according to an embodiment.

Referring to FIG. 7, in the case of the battle royale mode, before the game starts, a map of the field where the game play will take place may be provided to each user and each user may be allowed to select a game start location on the provided map within a preset time. In this case, on the map, a location where a specific field object (e.g., an item box) is placed may be displayed, and in the case of a team match the game start location selected by a user of the same team may be displayed. According to an embodiment, the preset time may be divided into a first time and a second time. Specifically, when the game start location selection starts, each user may freely select a desired location on the map during the first time, and the game start location selected during the first time may be changed during the second time after the first time ends. Meanwhile, if the user selects a game start location on the map within the preset time, the user's game character may be summoned at a location corresponding to the game start location selected by the user at the same time as the game starts. On the other hand, if the user does not select the game start location on the map within the preset time, the user's game character may be summoned at a random location at the same time as the game starts.

According to an embodiment, the Brawl mode may be a game mode in which each of a plurality of users selects a plurality of (e.g., three) game characters and then the plurality of users fight each other within a designated space until all of the selected game characters are dead. Meanwhile, in the Brawl mode, fewer people can participate compared to the battle royale mode and battles can take place in a relatively narrow space compared to the battle royale mode. Meanwhile, the Brawl mode may also be divided into an individual match and a team match in which a plurality of users form a team and play.

According to an embodiment, in the Brawl mode, each user may select his or her own game character through a game character selection screen, and one or more game characters selected by other users may be displayed on the game character selection screen provided to each user. For example, in the case of an individual match, at least one game character among a plurality of game characters selected by other users (e.g., if three game characters are selected, the first selected game character) may be displayed on the game character selection screen provided to each user. In addition, in the case of the team match, at least one game character among a plurality of game characters selected by each user of the other team (e.g., if three game characters are selected, the first selected game character) and all game characters selected by each user of the same team may be displayed on the game character selection screen provided to each user.

According to an embodiment, the build-up mode may be a game mode in which two users engage in a one-on-one battle in a narrow area. Meanwhile, the battle in the build-up mode may be conducted in a plurality of rounds. In this case, a user who kills the opponent's game character a preset number of times first in each round becomes a winner of the round, and the user who wins a preset number of rounds first may be determined as the final winner.

Meanwhile, according to an embodiment, in the build-up mode, each user may be given an opportunity to select an item to use in the next round each time each round ends before the final round ends. Specifically, at the end of each round, an item selection page displaying a plurality of selectable items may be displayed on each user's game play screen. In this case, the items displayed on the item selection screen may be randomly selected, and the number of items displayed on the item selection screen may be preset.

Meanwhile, according to an embodiment, the order of item selection of each user through the item selection screen may be determined based on the result of the previous round. For example, a user who lost in the previous round may be given priority in selecting items through the item selection screen. Specifically, a user who lost in the previous round may select a preset number of items from among the items displayed on the item selection screen within a preset time, and a user who won in the previous round may select a preset number of items from among the remaining items not selected by the losing user from among the items displayed on the item selection screen.

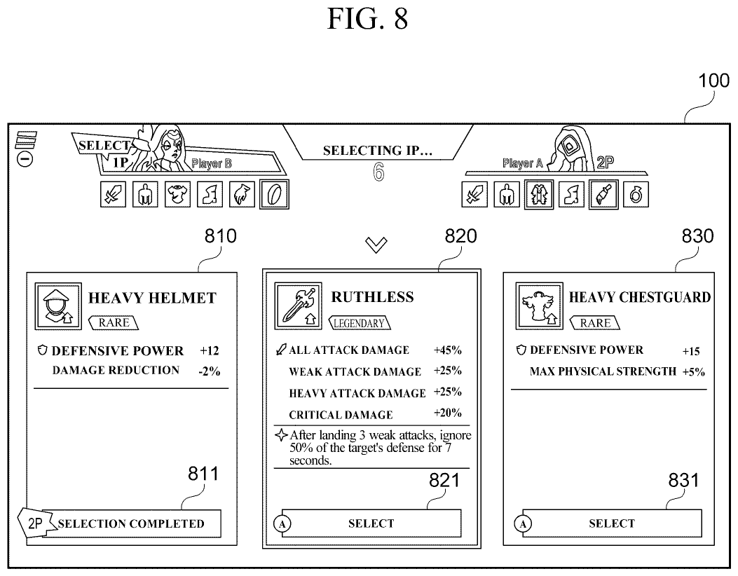

Specifically, FIG. 8 is a diagram for illustratively describing item selection in a build-up mode according to an embodiment.

Referring to FIG. 8, item selection areas 810, 820, and 830 for each of three randomly selected items may be displayed on an item selection screen, and information about each item may be displayed in the item selection areas 810, 820, and 830. In this case, as information about each item, information, such as an item image, item name, and grade of each item (e.g., legendary, rare, etc.), the effect of wearing the item, etc. may be displayed.

Meanwhile, item selection buttons 811, 821, and 831 may be displayed in item selection areas 810, 820, and 830. In this case, an item selection button 811 for an item already selected by another user may be displayed in a deactivated state with text indicating the selected user and that selection has been completed, and item selection buttons 821 and 831 for items not selected by another user may be displayed in an activated state with text indicating that selection is possible.

Specifically, as described above, in the item selection screen, priority may be given to the user who lost in the previous round and the user who lost may select one of three items by selecting the item selection button 811, 821, and 831 for one of the three items within a preset time. Meanwhile, if the user who lost selects a specific item within a preset time, the item selection button 821 for the selected item may be switched to an inactive state. Meanwhile, if the user who lost in the previous round selects a specific item within a preset time, the user who won in the previous round may select one of the remaining two items not selected by the user who lost within a preset time. In this case, according to an embodiment, if one of the remaining two items is selected by the user who won in the previous round, the remaining one item that was not selected may be processed as having been selected by the user who lost in the previous round.

Meanwhile, in the example described above, if a specific user does not select an item within a given time, the user may be given a randomly selected item from the selectable items or may be treated as not having selected an item.

Meanwhile, if each user's item selection through the item selection screen is completed, a subsequent round may be conducted, and in the subsequent round, the effect of wearing the item selected through the item selection screen may be applied to each user's game character.

Meanwhile, as described above, item selection through the item selection screen may be performed each time each round ends before the final round ends. In this case, the item selected through the item selection screen each time each round ends may be worn by the game character in a way that replaces the previously selected item or is added to the previously selected item. For example, if an item belonging to the same category as the previously selected item (e.g., weapon, hat, clothes, shoes, ring, gloves, etc.) is selected, the previously selected item may be replaced by the currently selected item. On the other hand, if the user character is not wearing an item belonging to the same category as the selected item, the user character may wear the newly selected item while still wearing the item that was previously worn.

Meanwhile, according to an embodiment, the item provided through the item selection screen may be determined based on a round progress situation. For example, if one of two users is unilaterally pushed back or the number of rounds that have been played increases, the probability of a high-grade item appearing may increase.

### Field Environment

A field of the game according to an embodiment may include a plurality of field objects. In this case, the field means a space in the game where the game play of users according to each game mode takes place. Specifically, each user may play the game according to a set rules within the field set according to the game mode. Meanwhile, according to an embodiment, at least one of a size of the field, a structure of the field, and a shape of the field may be different depending on the game mode and may be randomly determined each time the game is played. In addition, according to an embodiment, a type of field object placed in the field may vary depending on the game mode.

According to an embodiment, the field objects may include various types of objects that constitute an environment of the field, such as terrain, obstacles, and cover, or that are placed on the field and affect the movement or ability of the game character, or that the game character may utilize, or that may interact with the game character. Specifically, the field objects may include environmental objects, such as, for example, hills, walls, bushes, trees, bridges, water, rocks, buildings, and towers, item-related objects that provide items to the user's game character, such as item boxes, or objects that restore or increase the ability value of the game character (e.g. health, mana, defense, attack power, movement speed, etc.), or give special effects (e.g. granting resistance to certain attacks, granting attribute attack effects to game character attacks, etc.) to the user or other user's game character, or cause specific events (e.g. reviving dead party game characters).

Meanwhile, according to an embodiment, the field objects may include a deterministic object and a random object. In this case, the deterministic object may include an object that is placed at a specific location within the field from the start of the game or is deterministically generated at a specific location within the field at a predetermined time after the start of the game. For example, the deterministic object may include an environmental object such as, for example, a hill, a wall, a bush, a tree, a bridge, water, a rock, a building, a tower, etc., an object that affects the movement of the user character such as a jump pad, a teleportation gate, etc. However, the deterministic object is not necessarily limited to the examples described above and may include various types of objects in addition to the examples described above.

Meanwhile, the random object may include an object for which at least one of the generation time, the generation location, and whether-or-not-to-be-generated is randomly determined or determined based on the game progress situation. In this case, the game progress situation may include, for example, the location of each game character in battle within the field, the movement path thereof, the amount of movement thereof, the physical strength thereof, the number of remaining game characters, the time remaining until the end of the game, the number of surviving game characters per team, etc., but is not necessarily limited thereto, and may include various situations that may occur during the game progress depending on the embodiment.

For example, the random object may include an object generated at a random location within the field at a predetermined time, an object generated at a random time at a location randomly selected from among plurality of predetermined locations within the field, an object generated at a random location within the field at a random time, an object for which the generation time and generation location within the field are determined but whether-or-not-to-be-generated is determined arbitrarily, etc. As another example, the random object may include an object generated at a random location within the field based on the game progress situation, an object generated at a preset location within the field based on the game progress situation, an object whose generation is determined arbitrarily based on the game progress situation, etc.

As a specific example, the random object may include various types of objects that affect the ability values of game characters located nearby or passing by (e.g., decrease in physical strength, recovery of physical strength, decrease in movement speed, decrease in stamina, etc.), grant special abilities or buff effects (e.g., stealth effect, transformation effect, increase in stamina, increase in attack power, etc.) to game characters, or provide items to game characters.

Meanwhile, according to an embodiment, the generation probability of at least some of the random objects may be determined based on the game progress situation. In this case, according to an embodiment, the generation probability may be different for each area within the field. For example, the random objects may include objects that reduce the ability of game characters located nearby or passing by, such as an explosion zone that explodes and inflicts damage to game characters located within a certain distance, a swamp zone that reduces the movement speed of game characters passing by, a toxic zone that inflicts continuous damage to game characters passing by, etc. The generation probability of these random objects may be determined for each area within the field based on the location of each game character in battle within the field.

For example, the generation probability of the random object may be determined to have a higher probability in areas with a high density of game characters or areas where game characters stay for a long time based on the location of each game character in battle within the field. For a more specific example, the probability of generating an explosion zone or toxic zone may be determined so that an explosion zone or toxic zone is generated with a preset first probability (e.g., 40%) in the case of an area where the density of game characters is greater than a preset value for a preset time and an explosion zone or toxic zone is generated with a preset second probability (e.g., 20%) in the case of an area where the density of game characters is less than a preset value for a preset time.

Meanwhile, according to an embodiment, the field may be divided into a safe zone and a danger zone, and the safe zone may be updated at each preset area update cycle. Specifically, according to an embodiment, some areas within the existing safe zone may be set as a new safe zone each time each area update cycle starts, and the remaining areas except for the new safe zone may be changed to danger zones each time each area update cycle end. In this case, according to an embodiment, a location of the new safe zone may be randomly determined within the existing safe zone at each area update cycle. In addition, according to an embodiment, the size of the new safe zone may be preset at each area update cycle. For example, the size of the new safe zone may be preset as a ratio of the size of the existing safe zone (e.g., 50%). In this case, the ratio may be set to the same value for all area update cycles, or may be set to increase or decrease at a constant ratio each time the safe zone is updated according to the area update cycle.

Meanwhile, according to an embodiment, the danger zone may mean an area where a game character located in the area dies immediately or receives a preset penalty. For example, when a new update cycle starts, a game character located in the danger zone may be treated as dead immediately or may be summoned to a random location within the safe zone with a preset penalty (e.g., health reduction, item loss, etc.) applied. As another example, when a new update cycle starts, a game character located in the danger zone may continuously receive a preset penalty (e.g., health reduction) until the game character moves to a safe zone.

Meanwhile, according to an embodiment, a graphic effect that visually identifies the new safe zone and the remaining areas set at each area update cycle may be displayed in the field. In addition, according to an embodiment, the remaining time until the safe zone is updated according to the area update cycle may be displayed on the game play screen provided to each user. In addition, according to an embodiment, a new safe zone and a current location of the game character the user is playing may be displayed on a mini map displayed on a game play screen provided to each user.

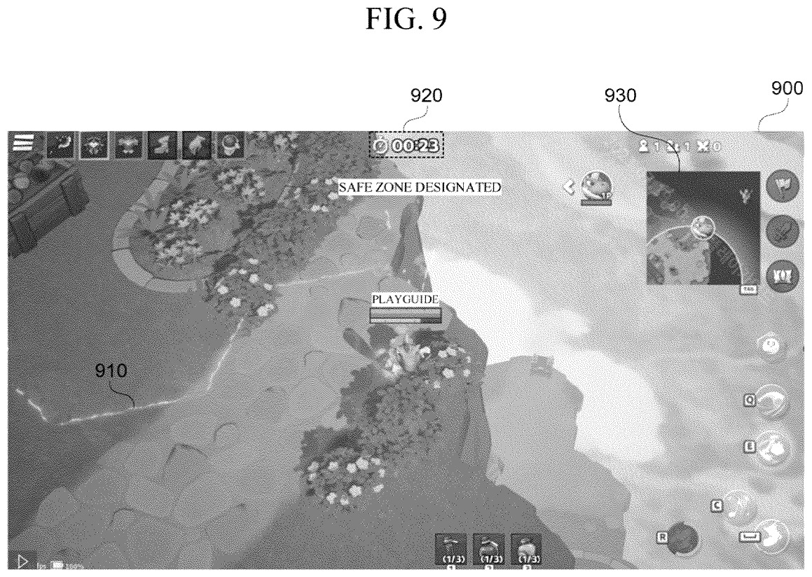

Specifically, as in the example illustrated in FIG. 9, a boundary line 910 between a new safe zone and the remaining areas may be displayed on the bottom of the field on a game play screen 900. In addition, the remaining time 920 until the safe zone is updated may be displayed on a game play screen 900, and the current location of the user character and the safe zone may be displayed on a mini map 930.

Meanwhile, graphic effects for visually identifying the safe zone and the remaining areas are not limited to the boundary line. For example, graphic effects to visually identify the safe zone and the remaining areas may include various graphic effects depending on the embodiment, such as the boundary line of an existing safe zone gradually moving over time, or a zone outside a new safe zone being displayed in a semi-transparent specific color.

Meanwhile, according to an embodiment, each time each update cycle ends, the remaining areas except for the new safe zone may be destroyed, for example, in a way of being exploded or collapsing the floor, may be changed to areas that game characters in the safe zone cannot enter, or areas where a preset penalty is imposed on the game characters that enter.

Meanwhile, according to an embodiment, some areas of the danger zone may be randomly generated within the safety zone regardless of the area update cycle. For example, some areas within the existing safe zone or the new safe zone may be randomly changed into the danger zone at any point in time in each area update cycle. In this case, the areas that have been changed into the danger zone may be destroyed, for example, by exploding or collapsing the floor, or changed into areas that game characters in the safe zone cannot enter, or changed into areas that impose a preset penalty on game characters that enter.

### Item

The game according to an embodiment may provide each user playing with various items that the user character can utilize.

According to an embodiment, the items may include consumable items and equipment items. In this case, the consumable items may mean items that have a set number of uses or a set amount, and that produces a preset effect occurs immediately or for a certain period of time when used. For example, the consumable items may include recovery items that restore specific ability values of the game character used, such as stamina recovery and mental power recovery, buff items that increase specific ability values of the game character (e.g. attack power, health, defense, stamina, movement speed, recovery speed, etc.) for a certain period of time, reduce the consumption of specific ability values of the game character for a certain period of time, add specific attribute (e.g. lightning, fire, cold, etc.) attacks to the game character's attacks for a certain period of time, grant the game character resistance to specific attribute attacks for a certain period of time, or grant the game character special abilities (e.g. stealth, stealth detection, transformation, teleportation, blood sucking effect, defense ignoring) for a certain period of time, summon items that summon specific field objects (e.g. springboard, item box, etc.), and event items that trigger specific events (e.g. resurrection of game characters of dead party), etc.

Meanwhile, equipment items may mean items that grant preset effects to the game characters while the game characters are holding or wearing the items, such as hats, clothes, weapons, rings, necklaces, amulets, etc. In this case, the effects granted by equipment items may include, for example, increasing the game character's ability values (e.g., attack power, defense power, stamina, health, etc.) or decreasing consumption thereof, granting special abilities (e.g., stealth, stealth detection, transformation, teleportation, blood sucking effect, defense ignoring, damage reduction, etc.), adding specific attribute (e.g., lightning, fire, cold, etc.) attacks to the game character's attacks, granting resistance to specific attribute attacks, etc.

Meanwhile, according to an embodiment, at least some items may appear probabilistically at preset locations or random locations within the field or may be probabilistically provided through specific field objects (e.g., item boxes) placed within the field. In addition, according to an embodiment, at least some items may be probabilistically provided when another user's game character is killed or may be selected by the user before or during the game (e.g., after the end of a round in build-up mode).

Meanwhile, according to an embodiment, an item may be granted one of a plurality of preset item grades (e.g., common, advanced, rare, legendary, mythic, set, etc.). In this case, the granted item grade may vary depending on the item type. In addition, the probability of an item appearing may vary depending on the item type, the granted item grade, etc.

Meanwhile, according to an embodiment, during the course of game, when an item of a specific grade (e.g., mythic grade) appears or before the item appears in the field, a notification message notifying that an item of the specific grade has appeared or is scheduled to appear may be displayed on the game play screen, or the appearance location or scheduled appearance location may be displayed on the mini map.

According to an embodiment, an item placed on the field may be automatically obtained based on the distance from the user's game character and the items held by the user's game character. In this case, the item placed on the field may be, for example, an item that is placed at a specific location on the field when the game starts, or that appears probabilistically at a specific location on the field at any point in time during game play, or that appears probabilistically on the field through interaction (e.g., opening an item box) between a game character and a field object (e.g., an item box) that provides the item. Specifically, according to an embodiment, when the user's game character approaches a specific item placed on the field within a preset distance, the item may be automatically obtained based on at least one of the item category and grade of the game item held by the game character and the item. For example, if the user's game character does not have an item belonging to the same category (e.g., armor, shoes, restorative medicine, etc.) as the specific item placed on the field, the specific item may be automatically obtained by the user's game character when the user's game character approaches within a preset distance. In addition, for example, if the user's game character has an item belonging to the same category (e.g., armor, shoes, restorative medicine, etc.) as a specific item placed on the field, but the grade of the specific item (e.g., myth grade, rare grade, etc.) is higher than the grade of the item held by the user's game character, the specific item may be automatically obtained by the user's game character when the user's game character approaches within a preset distance. On the other hand, if the user's game character has an item belonging to the same category as a specific item placed on the field, and the grade of the specific item is the same or lower grade than the grade of the item held by the user's game character, the specific item may not be automatically obtained by the user's game character even if the user's game character approaches within a preset distance.

### Battle System

According to an embodiment, battles between game characters may be conducted in a manner where each game character attacks and eliminates the opposing game character. Specifically, battles between game characters may be conducted in a manner where each game character uses skills such as, for example, attack, evasion, defense, and jump, depending on the user's operation, to push the other game character out of a preset area, ring it out, or eliminate the other game character by reducing the physical strength of the other game character to 0. Meanwhile, according to an embodiment, if the physical strength of the game character becomes 0, the game character may be immediately processed as having been eliminated. However, according to another embodiment, if the physical strength of the game character becomes 0, the game character may be set to not be immediately processed as having been eliminated, but to be in a state in which attack, defense, and movement are impossible for a preset period of time (e.g., groggy state). In this case, the game character may be processed as having been eliminated if the game character receives additional damage during the preset period of time. On the other hand, if the game character does not suffer additional damage for a preset period of time, the game character may be processed as having recovered physical strength by a preset amount.

Meanwhile, according to an embodiment, each game character that the user can play in the game may hold a skill corresponding to each of a plurality of preset skill categories. Specifically, according to an embodiment, the skill categories may be classified in various ways according to the method of use, the effect of use, the condition of use, the type of skill, etc. For example, the skill categories may be classified into attack skills, defense skills, movement skills, evasion skills, special skills, etc. according to the skill type, and at least one of the attack skills, defense skills, movement skills, and special skills may be further classified again into sub-skill categories according to the method of use, the effect of use, the condition of use, etc.

For a more specific example, in the case of attack skills, the attack skills may be categorized into basic attacks, skill attacks, linked attacks, etc. and basic attacks may be further categorized into weak attacks and strong attacks, for example, depending on the damage received by a hit game character. In addition, in the case of special attacks, for example, the special attacks may be classified into normal special attacks that can be used when the attack gauge is not fully charged, ultimate skills that can be used when the attack gauge is fully charged, etc., using an attack gauge that is charged according to specific conditions (e.g., attack success, defense success, parry success) or at a certain rate over time. In addition, in the case of the linked attacks, for example, the linked attacks may be classified into attacks (e.g., jump attack capable by linking jump action and basic attack) that can be used in conjunction with other skills or actions that are not attack skills, attacks that can be used when one attack skill is successively a preset number of times or when a plurality of attack skills are successively in a preset link order, etc.

Meanwhile, according to an embodiment, at least one of the skills used by each game character may be set to have a specific usage condition or may be set to consume a specific ability (e.g., stamina, mental power) of the game character. For example, at least one of the basic attacks, evasion skills, defense skills, and movement skills may be set to consume a preset amount of stamina of the game character. As another example, a normal special attack may be set to consume a preset amount of attack gauge each time it is used, and an ultimate skill may be set to consume the entirely attack gauge each time it is used. As another example, in the case of a special skill, usage conditions such as the number of uses, reusable time, etc. may be set.

Meanwhile, according to an embodiment, at least one of the skill usage action, skill usage effect (e.g., amount of damage received when hit, special effects (e.g., freezing, poisoning, stun, etc.)), skill usage types (e.g., attack range, attack direction, ranged attack, melee attack, etc.), skill usage tools (e.g., bat, sword, axe, bow, gun, etc.), skill attributes (e.g., ice attribute, fire attribute, lightning attribute, etc.), and skill usage speed for skills belonging to the same skill category may be different for each game character. For example, in the case of the basic attacks, at least one of the attack motion, hit damage, attack speed, and attack type may be different for each game character, and in the case of the special skills, at least one of the skill usage motion and skill usage effect may be different for each character.

### Configuration of Game Play Screen and Game Character Operation

According to an embodiment, the game play screen may include various UIs such as a UI for game character operation, a UI for providing information related to a game play situation, a UI for providing information related to an item, etc. In this case, the game play screen may mean a screen where game play is conducted according to a user's operation.

According to an embodiment, at least one of the type, position, and shape of the UI displayed on the game play screen may be changed according to at least one of the type of gaming device on which the game is executed, the type of an input device used for game play, and the game mode.

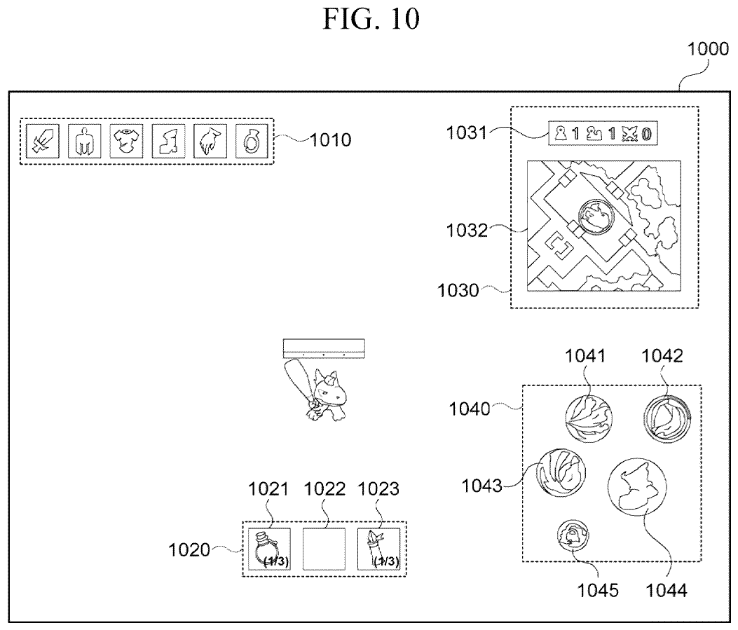

Specifically, FIGS. 10 to 12 are diagrams for illustratively describing the configuration of the game play screen according to an embodiment.

Referring to FIGS. 10 to 12, a game play screen 1000 may include a UI 1010 that provides information on equipment items worn by the user's game character, a UI 1020 that provides information on consumable items held by the user's game character, a UI 1030 that provides information related to game play situations, a UI 1040 related to game character operation, etc.

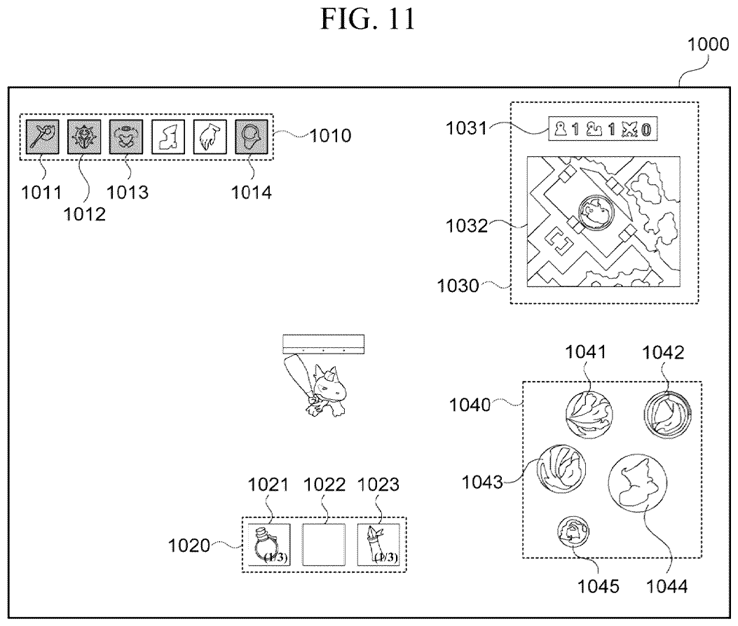

Specifically, the UI 1010 that provides information on equipment items being worn may include a plurality of slots, each corresponding to an equipment item of a specific category. In this case, equipment items of a corresponding category among equipment items being worn by the user's game character may be displayed in each slot. For example, if there is no equipment item being worn by the user's game character, a preset default image indicating a category of a corresponding equipment item may be displayed in each slot of the UI 1010 as in the example illustrated in FIG. 10. On the other hand, if the user's game character is wearing one or more equipment items, an item image corresponding to the equipment item being worn may be displayed in slots 1011, 1012, 1013, and 1014 corresponding to a category of each equipment item being worn, as in the example illustrated in FIG. 11. In this case, according to an embodiment, a default image may be displayed in black and white, and the item image may be displayed in color. In addition, according to an embodiment, preset graphic effects (e.g., changing the background or border color of the slot, highlight effects, etc.) indicating the grade (e.g., rare, legendary, etc.) of the equipment item being worn may be displayed on the slots 1011, 1012, 1013, and 1014 where the item image is displayed.

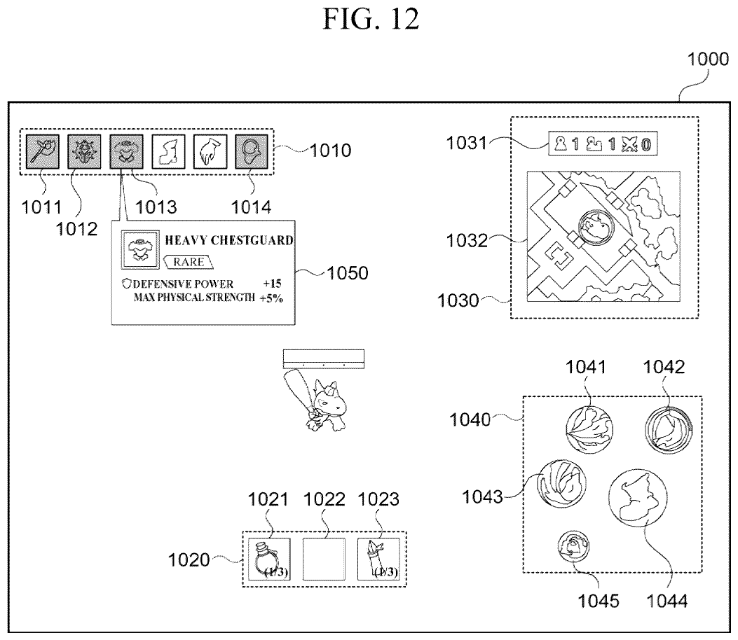

Meanwhile, according to an embodiment, when a specific slot is selected from among the slots 1011, 1012, 1013 and 1014 in which an item image is displayed by user input, item information about the equipment item corresponding to the specific slot among the equipment items being worn by the user's game character may be displayed on the game play screen. In this case, the item information may include information about the item image, item name, item grade, item wearing effect, etc., and may be displayed in the form of a pop-up window 1050 as in the example illustrated in FIG. 12.

Meanwhile, the UI 1020 providing information on consumable items may include slots corresponding to each consumable item that the game character can hold. In this case, the corresponding consumable item image and the holding amount may be displayed in the slots 1021 and 1023 for consumable items held by the game character, and the slot 1022 for consumable items that the game character does not hold may be displayed as an empty slot. Meanwhile, the holding amount may include the maximum holding amount and the current holding amount as in the examples illustrated in FIGS. 10 to 12. According to an embodiment, if the maximum holding amount is not determined, the holding amount may include only the current holding amount.

Meanwhile, the UI 1030 providing information related to the game play situation may include, for example, situation information 1031 related to the current battle situation and a mini map 1032. In this case, the situation information 1031 may include various information that changes as the game play progresses, such as the number of currently surviving friendly game characters, the number of game characters eliminated by the user's game character, etc. Meanwhile, a map of the field where the game play is progressing may be displayed in a reduced form on the mini map 1032. On the mini map 1032, for example, the location of the user's game character, the location of a specific field object, the location of an item generation, etc. may be displayed, and depending on the game mode, the location of at least one of the friendly game character and the enemy game character may be displayed.

Meanwhile, according to an embodiment, the UI 1040 related to the game character operation may include a plurality of UI elements 1041, 1042, 1043, 1044, and 1045. Specifically, for each UI element 1041, 1042, 1043, 1044, and 1045, one of actions that the user's game character can perform may be set as a corresponding action. In this case, the corresponding action may include, for example, evasion, jumping, defense, weak attack, strong attack, use of special skills, etc., but is not necessarily limited thereto, and may vary depending on the embodiment. In addition, depending on the embodiment, the corresponding action for each of UI elements 1041, 1042, 1043, 1044, and 1045 may be preset by the user.

Meanwhile, the user's game character may perform an action corresponding to each of UI elements 1041, 1042, 1043, 1044, and 1045 based on user input related to each of UI elements 1041, 1042, 1043, 1044, and 1045. In this case, the user input related to each of UI elements 1041, 1042, 1043, 1044, and 1045 may include, but is not necessarily limited to, touch, click, preset key operation, etc. for each of UI elements 1041, 1042, 1043, 1044, and 1045, and may vary depending on the type of gaming device or input device used for game play.

Meanwhile, each of UI elements 1041, 1042, 1043, 1044, and 1045 may be displayed in the form of a button in which a graphic image related to the corresponding action displayed inside thereof is displayed. In addition, for example, in the case of the UI element 1042 corresponding to an action for which a usage condition is set, such as a special skill for which a reuse time is set, a preset graphic image indicating whether the usage condition is met may be displayed.

Meanwhile, according to an embodiment, for at least one attack skill (e.g., a special skill, an ultimate skill, etc.) used by a user's game character, a graphic image representing at least one of an attack type, an attack range, and an attack direction of the attack skill to be used by the user's game character may be displayed on the game play screen according to a preset user input.

For example, if a user clicks or touches a UI element corresponding to a specific attack skill of a game character for a certain period of time, a graphic image representing at least one of the attack type, attack range, and attack direction of the specific attack skill may be displayed on the game play screen.

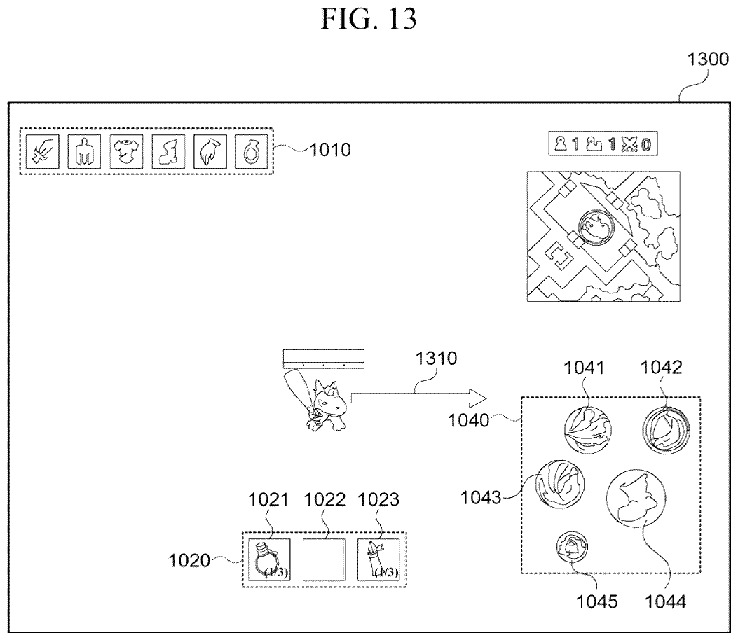

Specifically, FIGS. 13 to 16 are diagrams for illustratively describing graphic images representing at least one of an attack type, an attack range, and an attack direction of a specific attack skill according to an embodiment.

Referring to FIG. 13, if a specific attack skill is an attack that fires a projectile (e.g., a bow, a bullet, etc.) in a straight line, a graphic image 1310 in the form of an arrow representing a launch path and direction of the projectile may be displayed on the game play screen 1300 based on a user input (e.g., clicking or holding a touch state for a certain period of time) for a UI element corresponding to the attack skill.

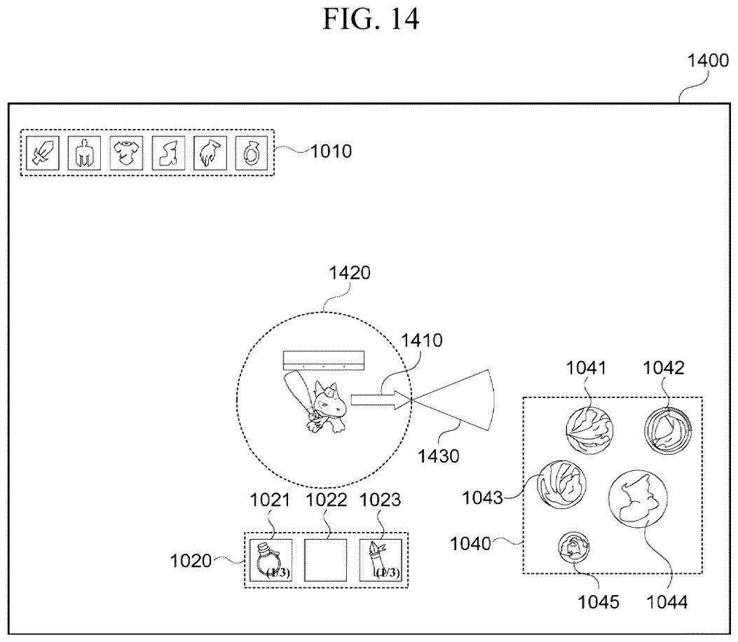

As another example, if a specific attack skill is an attack that the projectile flies in a straight line and explodes at a specific distance and spreads out at a specific angle, as illustrated in the example of FIG. 14, a graphic image in which an arrow 1410 indicating the direction and distance that the attack flies in a straight line, a circle 1420 indicating a point where the attack type changes, and a fan shape 1430 indicating the angular range that the attack spreads out may be displayed on the game play screen 1400 based on a user input (e.g., clicking or holding a touch state for a certain period of time) for a UI element corresponding to the attack skill.

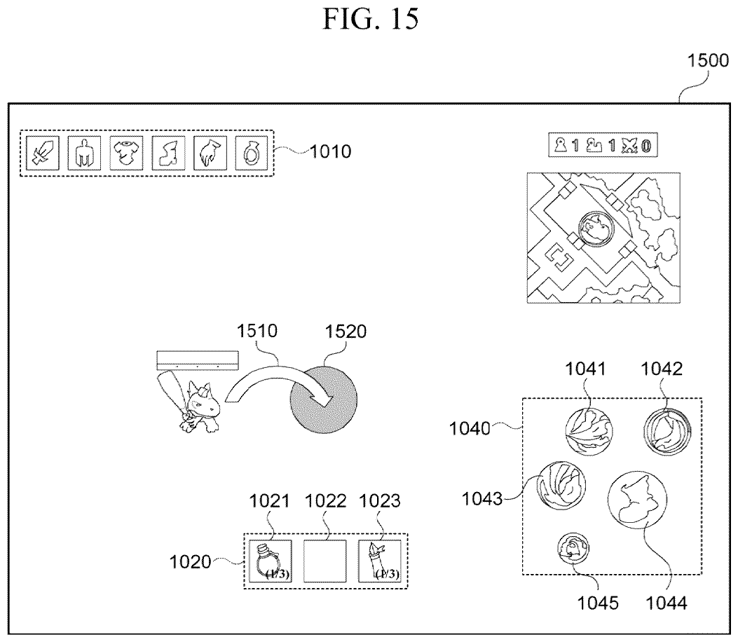

As another example, if a specific attack skill is an attack that causes a projectile to fly in a curved shape and then inflict damage to an area within a certain range from the point where the projectile fell, as illustrated in the example of FIG. 15, a graphic image in which an arrow 1510 indicating the curved path along which the projectile flies and the point at which the projectile falls and a circle 1520 indicating the range of damage inflicted from the point at which the projectile fell may be displayed on the game play screen 1500 based on a user input (e.g., clicking or holding a touch state for a certain period of time) for a UI element corresponding to the attack skill.

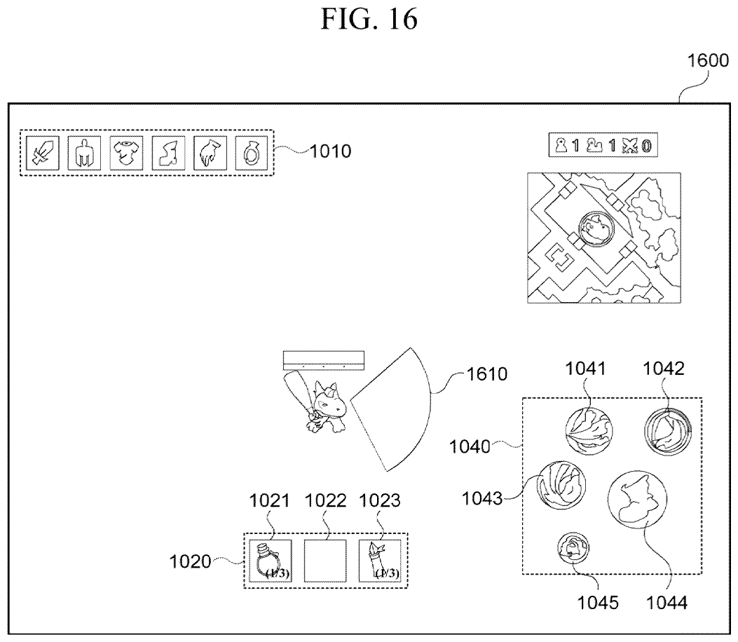

As another example, if a specific attack skill is an attack in which a melee weapon (e.g., a knife, a bat, etc.) is swung, as illustrated in the example of FIG. 16, a fan-shaped graphic image 1610 indicating the angle and distance of swinging the melee weapon may be displayed on the game play screen 1600 based on a user input (e.g., clicking or holding a touch state for a certain period of time) for a UI element corresponding to the attack skill.

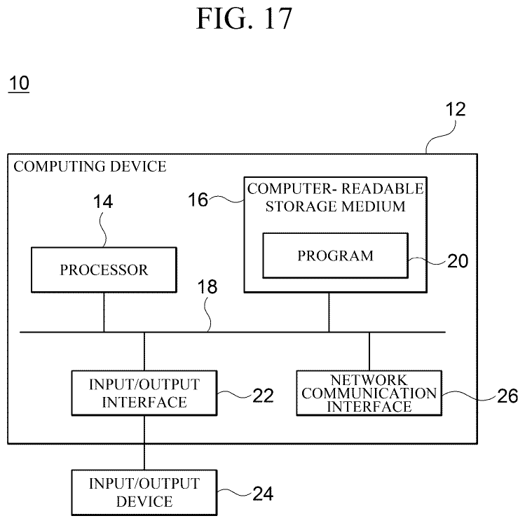

FIG. 17 is a block diagram for describing a computing environment 10 including a computing device suitable for use in exemplary embodiments.

In the embodiment illustrated in FIG. 17, respective components may have different functions and capabilities other than those described below, and may include additional components in addition to those described below.

The illustrated computing environment 10 includes a computing device 12. The computing device 12 is for providing a game according to the embodiments described above and may be, for example, one or more components included in a gaming device.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

Although representative embodiments of the present disclosure have been described in detail, a person skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents to the claims.

What is claimed is:

1. A method performed by a computing device including one or more processors, the method comprising:
determining a generation probability for one or more random objects to be placed on a field based on a game progress situation within the field where game play of a plurality of users is performed; and
generating the one or more random objects on the field based on the generation probability.

2. The method of claim 1, wherein the one or more random objects include an object for which at least one of generation time, generation location, and whether-or-not-to-generate is determined based on the game progress situation.

3. The method of claim 1, wherein the game progress situation includes at least one of a position of a game character of each of the plurality of users within the field, a movement path of the game character of each of the plurality of users, a movement amount of the game character of each of the plurality of users, a physical strength of the game character of each of the plurality of users, a number of remaining game characters among game characters of each of the plurality of users, and a remaining time until the end of the game.

4. The method of claim 3, wherein the determining comprises determining the generation probability for each area within the field based on the location of the game character of each of the plurality of users within the field.

5. The method of claim 4, wherein the determining further comprises determining the generation probability so that an area with a higher density of game characters for each of the plurality of users within the field has a higher generation probability.

6. The method of claim 4, wherein the determining further comprises determining the generation probability so that an area where the game character of each of the plurality of users stays for a longer time has a higher generation probability.

7. The method of claim 1,
wherein the field includes a safe zone and a danger zone,
the safe zone is updated at each preset area update cycle, such that some areas within an existing safe zone are set as a new safe zone each time the area update cycle starts, and remaining areas within the existing safe zone, excluding the new safe zone, are changed to the danger zone each time the area update cycle ends, and
some areas of the danger zone are randomly generated within the existing safe zone or the new safe zone regardless of the area update cycle.

8. A computing device comprising:
one or more processors; and
a memory storing one or more programs executed by the one or more processors,
wherein the one or more processors are configured to:
determine a generation probability for one or more random objects to be placed on a field based on a game progress situation within the field where game play of a plurality of users is performed; and
generate the one or more random objects on the field based on the generation probability.

9. The computing device of claim 8, wherein the one or more random objects include an object for which at least one of generation time, generation location, and whether-or-not-to-generate is determined based on the game progress situation.

10. The computing device of claim 8, wherein the game progress situation includes at least one of a position of a game character of each of the plurality of users within the field, a movement path of the game character of each of the plurality of users, a movement amount of the game character of each of the plurality of users, a physical strength of the game character of each of the plurality of users, a number of remaining game characters among game characters of each of the plurality of users, and a remaining time until the end of the game.

11. The computing device of claim 10, wherein the one or more processors are further configured to determine the generation probability for each area within the field based on the location of the game character of each of the plurality of users within the field.

12. The computing device of claim 11, wherein the one or more processors are further configured to determine the generation probability so that an area with a higher density of game characters for each of the plurality of users within the field has a higher generation probability.

13. The computing device of claim 11, wherein the one or more processors are further configured to determine the generation probability so that an area where the game character of each of the plurality of users stays for a longer time has a higher generation probability.

14. The computing device of claim 8,
wherein the field includes a safe zone and a danger zone,
the safe zone is updated at each preset area update cycle, such that some areas within an existing safe zone are set as a new safe zone each time the area update cycle starts, and remaining areas within the existing safe zone, excluding the new safe zone, are changed to the danger zone each time the area update cycle ends, and
some areas of the danger zone are randomly generated within the existing safe zone or the new safe zone regardless of the area update cycle.
